(19) United States
(12) Patent Application Publication
(10) Pub. No.: US 2026/0311423 A1
(43) Pub. Date: Oct. 8, 2026

(54) NEURAL VIEW-DEPENDENT PRINCIPLED BRDF ADAPTER

(71) Applicants: Disney Enterprises, Inc., Burbank, CA (US); ETH Zürich (Eidgenössische Technische Hochschule Zürich), Zürich (CH)

(72) Inventors: Rajesh SHARMA, Zürich (CH); Sebastian Klaus WEISS, Zürich (CH); Tiziano Andrea PORTENIER, Zürich (CH); Marios PAPAS, Zürich (CH)

(73) Assignees: Disney Enterprises, Inc., Burbank, CA (US); ETH Zürich (Eidgenössische Technische Hochschule Zürich), Zürich (CH)

(21) Appl. No.: 19/637,968

(22) Filed: Apr. 2, 2026

Related U.S. Application Data
(60) Provisional application No. 63/783,850, filed on Apr. 4, 2025.

(51) Int. Cl. G06T 15/50; G06T 15/20

(52) U.S. Cl. CPC G06T 15/506; G06T 15/20

(57) ABSTRACT

A neural network-based method and system are disclosed for adapting parameters of a source bidirectional reflectance distribution function (BRDF) to a target BRDF, enabling efficient and expressive material rendering. Some aspects include generating or receiving BRDF data for a plurality of source materials as a function of incoming and outgoing light directions, aggregating the data into a representation suitable for machine learning, and training a neural network to map source BRDF parameters and viewing direction to target BRDF parameters. The trained network is used to predict target BRDF parameters, which are supplied to a rendering engine for visualization. The approach supports both measured and simulated materials, employs flexible data aggregation strategies such as uniform or adaptive binning, and may utilize encoder-decoder architectures for multi-material adaptation and can thus achieve visual fidelity of complex materials while maintaining compatibility with existing parametric rendering systems, facilitating efficient, view-dependent rendering for diverse applications.

### CROSS-REFERENCE TO RELATED APPLICATIONS

This application claims the benefit of U.S. Provisional Application No. 63/783,850, filed on Apr. 4, 2025, and entitled “NEURAL VIEW-DEPENDENT PRINCIPLED BRDF ADAPTER,” is herein incorporated by reference in its entirety for all purposes.

### BACKGROUND

Models that attempt to simulate light and material interaction can be broadly classified into two main categories: (1) non-neural parametric models, and (2) neural methods that learn from material data.

Non-neural parametric models attempt to simulate light and material interaction using physical properties of materials often approximating the material surface as a microfacet model. For data from measured materials, non-neural methods use techniques like Principle Component Analysis (PCA) or other optimization methods to map measured data as closely as possible to existing parametric models. Parametric appearance models currently used in production can be very efficient to evaluate and sample but are limited in terms of capturing complex appearance (e.g., multi-layer materials, measured materials, etc.) for which additional parameters and computation may be needed. Moreover, creating and adding new appearance models to existing production renderers is non-trivial and introduces additional parameters and complexity for artists.

Current neural methods collect data from an existing parametric model or utilize directly measured data and learn the bidirectional reflectance distribution function (BRDF) of the material using a neural process. Fully neural appearance models can be more expressive than existing parametric models, but they are computationally expensive and slow to evaluate and sample efficiently, especially on CPUs on which many production renderers are based. The learning is performed without regard to a target BRDF. Instead, they learn to predict the BRDF directly and require a custom renderer that can then interpret the learned BRDF.

These existing solutions need to implement costly methods for importance sampling involving additional neural methods or inverting the cumulative distribution function (CDF) using the tabulated BRDF values. This makes the rendering process costly and induces overhead in terms of computation and memory. These methods also do not allow much control over the parameters once the material has been learned. Better solutions to these problems are needed.

### BRIEF SUMMARY OF THE INVENTION

Embodiments disclosed herein provide a solution that brings in the best of both worlds of expressiveness and efficiency. According to some embodiments, a hybrid neural adapter is disclosed that uses smaller neural networks to produce on-the-fly the corresponding parameters for existing non-neural parametric models which match the expressiveness of fully neural appearance models. This allows for smaller networks that are efficient to evaluate and importance sample on CPUs while matching the expressiveness of more expensive fully neural appearance models. A benefit is that richer materials can now be efficiently rendered in existing rendering software.

Some embodiments disclosed herein learn to map the BRDF directly to the parameters of the target BRDF making it simpler to implement in an existing renderer that already has the target BRDF efficiently implemented. Additionally, embodiments disclosed herein are more suitable for artistic control because the parameters can be altered easily if the artists are not satisfied with the visual results using the familiar user interface of the renderer that uses the target BRDF.

In certain embodiments, a method for adapting a source bidirectional reflectance distribution function (BRDF) to a target BRDF using a neural network, the method comprises: generating data for a plurality of source materials including measured or simulated BRDF values; aggregating the generated data into a multi-dimensional representation of incoming and outgoing light directions; training a neural network to map source BRDF parameters and viewing direction to target BRDF parameters; conditioning the neural network on source BRDF control parameters and viewing direction; and predicting parameters of the target BRDF for rendering purposes; rendering the material using the predicted target BRDF parameters in an existing rendering engine. In some cases, the method can include enabling modification (e.g., user modification) of source parameters to alter a rendered appearance, which can allow for artist control. In some cases, the neural network comprises a multi-layer perceptron (MLP) with at least three hidden layers and at least twelve output nodes corresponding to target BRDF parameters. The method can further include generating training data by sampling direction pairs over a sphere and aggregating samples using uniform or adaptive binning strategies. In some implementations, adaptive binning is performed using a KD-tree structure to emphasize high-intensity areas of the BRDF data. The training of the neural network can be supervised using a loss function comparing target BRDF output to average values of sampled bins, utilizing importance sampling for high-energy samples. The method can further comprise extending the neural network to encode multiple materials using an encoder-decoder architecture, wherein different encoders process different input modalities and output a shared latent code for decoding material parameters. In some cases, the neural network enables view-dependent adaptation by conditioning on the viewing direction without conditioning on the light direction, thereby facilitating efficient importance sampling in rendering.

In some implementations, a system for neural view-dependent adaptation of BRDF parameters comprises: a data generation module configured to simulate or measure material BRDFs; an aggregation module configured to organize data into multi-dimensional bins; a neural network module configured to map source BRDF parameters and viewing direction to target BRDF parameters; an encoder-decoder architecture for handling multiple materials; and a rendering engine configured to render materials using the predicted target BRDF parameters. The data generation module may comprise Monte Carlo sampling of incoming and outgoing directions over the sphere. The aggregation module can be further configured to perform adaptive binning using a KD-tree structure. In some implementations, the neural network module includes a multi-layer perceptron with trainable weights, configured to output at least twelve parameters for the target BRDF. The encoder-decoder architecture includes encoders for various input modalities and decoders for predicting target BRDF parameters from a shared latent code. The rendering engine can be configured for efficient importance sampling and artist-controllable parameter modification. In some embodiments, the neural network module is trained end-to-end on a corpus of materials to optimize rendering accuracy and generalizability.

In certain embodiments, a non-transitory computer-readable medium storing instructions that, when executed by a processor, cause the processor to perform a method for neural view-dependent BRDF adaptation, the method comprises: receiving source BRDF data; aggregating data into bins based on incoming and outgoing directions; training a neural network to map source parameters and viewing direction to target BRDF parameters; and predicting target BRDF parameters for rendering. In some cases, the instructions further cause the processor to perform adaptive binning of BRDF data using a KD-tree structure. The instructions can further cause the processor to supervise training using a loss function comparing predicted RGB values to aggregated bin averages. In some cases, the instructions further cause the processor to extend the neural network to encode multiple materials using an encoder-decoder architecture. In further embodiments, the instructions further cause the processor to enable view-dependent adaptation by conditioning the neural network on viewing direction but not on light direction. In some aspects, the instructions further cause the processor to allow a modification of source parameters to alter rendered appearance.

To better understand the nature and advantages of the present invention, reference should be made to the following description and the accompanying figures. It is to be understood, however, that each of the figures is provided for the purpose of illustration only and is not intended as a definition of the limits of the scope of the present invention. Also, as a general rule, and unless it is evident to the contrary from the description, where elements in different figures use identical reference numbers, the elements are generally either identical or at least similar in function or purpose.

The terms and expressions that have been employed are used as terms of description and not of limitation, and there is no intention in the use of such terms and expressions of excluding any equivalents of the features shown and described or portions thereof. It is recognized, however, that various modifications are possible within the scope of the systems and methods claimed. Thus, it should be understood that, although the present system and methods have been specifically disclosed by examples and optional features, modification and variation of the concepts herein disclosed should be recognized by those skilled in the art, and that such modifications and variations are considered to be within the scope of the systems and methods as defined by the appended claims.

This summary is not intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim.

The foregoing, together with other features and examples, will be described in more detail below in the following specification, claims, and accompanying drawings.

### BRIEF DESCRIPTION OF THE DRAWINGS

The features of the various embodiments described above, as well as other features and advantages of certain embodiments of the present invention will be more apparent from the following detailed description taken in conjunction with the accompanying drawings, in which:

Throughout the drawings, it should be noted that like reference numbers are typically used to depict the same or similar elements, features, and structures.

FIG. 1 is a simplified illustration of a source bidirectional reflectance distribution function (BRDF) in a two-layer configuration with associated parameters;

FIG. 2 is a simplified overview of a pipeline, according to some embodiments;

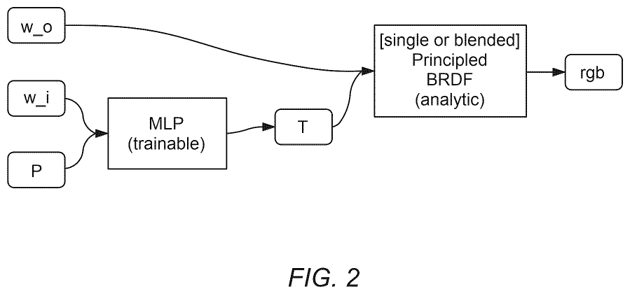

FIG. 3A is a simplified diagram illustrating sampling of a hemisphere given two uniform random numbers in the (0, 1] range;

FIG. 3B is a simplified illustration of an adaptive binning strategy over wo for one wi-slice where the upper portion of FIG. 3B (a) shows the generated bins with random colors and the lower portion of FIG. 3B (b) shows the bins with their color based on the sampled data;

FIG. 4 is a simplified diagram depicting an Encoder-Decoder architecture for multiple materials, according to some embodiments;

FIG. 5 is a simplified diagram depicting possible implementations for MLP decoders predicting non-wi-depending BRDF parameters, according to some embodiments;

FIGS. 6A-6C are simplified diagrams depicting different, alternative architectures for multi-material wi-dependent decoders, according to some embodiments;

FIG. 7 is a simplified flow chart showing aspects of a method for adapting a source bidirectional reflectance distribution function (BRDF) to a target BRDF using a neural network, according to certain embodiments; and

FIG. 8 shows a computer system 800 for performing aspects of the invention described herein.

### DETAILED DESCRIPTION

Aspects of the present disclosure relate generally to computer graphics and material rendering, and more particularly to systems and methods for adapting a source bidirectional reflectance distribution function (BRDF) to a target BRDF using a neural network, according to certain embodiments.

In the following description, various examples of a hybrid neural adapter that uses smaller neural networks to produce on-the-fly the corresponding parameters for existing non-neural parametric models are described. These examples are provided to illustrate some of the novel principles of the invention and their application in practical rendering scenarios.

The following high-level summary is intended to provide a basic understanding of some of the novel innovations depicted in the figures and presented in the corresponding descriptions provided below. Aspects of the invention relate to a novel neural-BRDF adapter that addresses the limitations of existing material rendering models. The disclosed system utilizes a small, efficient multi-layer perceptron (MLP) to map the parameters of a complex source material to the parameters of an existing, production-ready target BRDF. This mapping is critically conditioned on the viewing direction, allowing the adapter to accurately capture sophisticated, view-dependent effects characteristic of multi-layered materials By doing so, the invention achieves the expressiveness and richness of fully neural models while retaining the computational efficiency and trivial sampling of analytical models. This hybrid approach maintains full artistic controllability and can be extended to handle a wide corpus of materials through an encoder-decoder architecture. For purposes of explanation, specific configurations and details are set forth in order to provide a thorough understanding of the embodiments. However, it will be apparent to one skilled in the art that certain embodiments may be practiced or implemented without every detail disclosed. Furthermore, well-known features may be omitted or simplified in order to prevent any obfuscation of the novel features described herein.

It is to be understood that this high-level summary is presented to provide the reader with a baseline understanding of some of the novel aspects of the present disclosure and a roadmap to the details that follow. This high-level summary in no way limits the scope of the various embodiments described throughout the detailed description and each of the figures referenced above are further described below in greater detail and in their proper scope.

State-of-the-art parametric models of complex materials (layered materials, hair, cloth) can convincingly represent real-world materials but are compute-intensive, require several additional parameters and are hard to incorporate into existing rendering systems. While recent advances in neural network representation of complex materials have shown great promise, these representations can require large networks that are slow to train and evaluate. For instance, fully neural representations often require custom rendering pipelines that can interpret the learned BRDF, creating a significant barrier to adoption in established production environments. Furthermore, importance sampling these neural representations is often non-trivial, requiring additional complex networks or costly numerical inversion techniques to be efficient. Neural materials are also challenging to sample efficiently.

According to embodiments disclosed herein, a neural-BRDF adapter is provided that trains a small MLP to map classes of materials to directionally varying parameters of an existing parametric BRDF. The directionally varying conditioning can capture the richness of complex materials but is also efficient to evaluate, owing to the small size of the MLP. Moreover, since the resulting parameters are part of an existing analytical model, the sampling is trivial.

Some embodiments tackle the aforementioned problems of limited parametric vs. expensive neural models using a hybrid approach. To facilitate an understanding of disclosed embodiments, the discussion below is based on a case of training an adapter from the analytical 2-layer material model as described (the source) to a Principled BRDF (the target). The Principled BRDF, often used in production renderers, is a physically-based model that consolidates various material properties into a small, artist-friendly set of parameters. The source BRDF, conversely, can be a highly complex and computationally expensive model, such as a multi-layer material simulation or tabulated data from a physical measurement device like a gonioreflectometer. A skilled artisan will recognize that any source or target BRDF is applicable provided that the target model is differentiable.

In the example, the source BRDFs is the material to be approximated. This material could be measured, i.e., available in tabulated form requiring lots of memory and is difficult to sample or could be accurately but expensively simulated. Let P be the set of parameters influencing the behavior of the source BRDF.

The target BRDFt is the material to be adapted to. This BRDF can be easily evaluated and importance sampled. Let T be the set of parameters governing the behavior of target BRDFt.

While the target BRDF cannot approximate the source BRDF closely for a constant T given a specific P, it does approximate it well when T is varied based on the viewing direction w_i. By allowing the target parameters T to vary with the viewing direction, the model can fit a different, simpler BRDF shape at each angle, and the combination of these simple shapes effectively reconstructs the complex behavior of the source BRDF.

More formally, a function f: P, w_i→T is used that estimates target parameters T given the control parameters P of the source BRDF and the viewing direction w_i.

By conditioning f on P, full artist-controllability is retained: the material can be edited by controlling the semantic parameters already exposed by the source BRDF instead of, e.g., a trained latent space. This can be a significant advantage over many end-to-end neural rendering systems where artists are forced to edit abstract latent codes, which lack a direct, intuitive link to physical material properties.

By conditioning f on w_i, view-dependent effects as typically seen in multi-layered materials can be modeled while still retaining the ability to importance-sample the target BRDF since the process does not condition on the light direction w_o. Since importance sampling in a path tracer is performed by sampling the light direction w_o for a given viewing direction w_i, keeping the BRDF parameters constant with respect to w_o means that the existing, highly optimized sampling routines of the target BRDF can be used without modification.

In some embodiments, the function f is modeled as a small multi-layer perceptron f_θ with trainable weights θ.

### Details on the Architecture and the Training Scheme

The neural network itself can be a small, fully connected network (MLP) with 3 hidden layers, 32 neurons per layer, and 12 output nodes. The input layer is configured to accept a concatenated vector of the source BRDF parameters P and the viewing direction w_i, often represented as a 3D Cartesian vector. Rectified Linear Unit (ReLU) or similar activation functions are typically used in the hidden layers to introduce the non-linearity required to learn the complex mapping from source parameters to target parameters. Each output may corresponds to the 12 parameter values of the target BRDF.

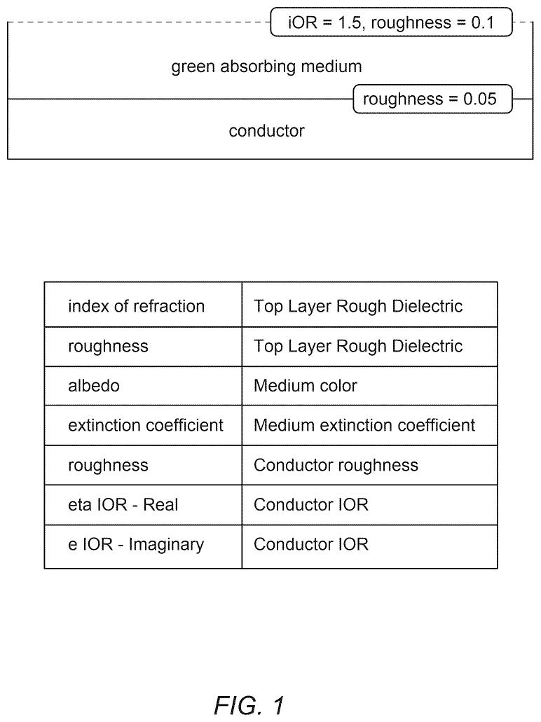

Data is generated for a large number of layered materials in a two-layer configuration. The parameters for the configuration are described in FIG. 1. By varying these parameters in plausible ranges, 1200 materials are generated. Data is generated and aggregated for each such material, as described in the next section. This large and diverse dataset is essential for training a network that generalizes well, preventing overfitting to a small subset of materials and ensuring it can accurately predict parameters for novel material configurations it has not seen during training. In total, 40×80×40×80 bins per material are generated, covering the entire 4D space of wi and wo directions.

In some embodiments, f_θ can be trained on the data [P, w_i, w_o; RGB], where Tis not directly supervised.

### Data Generation and Aggregation

The training data is represented using a 4-dimensional tabulation that maps (w_i, w_o) pairs to RGB values. While response measurements of real-world materials are often represented in this form, simulated models such as must be sampled explicitly. The process for sampling and aggregating such samples is now described.

### Uniform Aggregation

The Guo source model maps an incoming direction w_i to an RGB value and an outgoing direction w_o, i.e., g: P, w_i→w_o, RGB. Let a bin represent a single cell in our 4D array. To sample the source model, we first generate directions w_i_i distributed over the sphere. We then use g to obtain (w_o, RGB) values and store the RGB value at (w_i, w_o) in the 4D array. Without prior knowledge of the shape of g, a reasonable binning approach uniformly partitions the 4D space into equally sized bins. It is important to bin the domain uniformly in solid angle measure. Binning uniformly in (theta, phi) would result in non-uniform bin sizes (smaller bins towards the poles, larger bins around the equator). A uniform solid angle measure ensures that each bin corresponds to an equal area on the surface of the unit sphere, which is critical for unbiased sampling and integration in physically-based rendering.

Since the Guo simulation involves Monte-Carlo sampling to evaluate g(P, w_i), evaluating a single sample per bin results in noisy training data, which hinders the training process. Therefore, many (w_i)s per bin are sampled, and the resulting RGB values are averaged. This averaging process can effectively function as a low-pass filter, reducing the high-frequency noise inherent in Monte-Carlo methods and providing a stable, representative value for each bin that is more suitable for supervised learning. The bin average can be unbiasedly estimated using the following formula:

Average bin value calculation:

$${\tilde{f}}_{B} = \frac{1}{{Ω}_{B}} {\int }_{B} f ( {w}_{i} , {w}_{0} ) {dw}_{i} {dw}_{0} \qquad ( 1 )$$

where Ω_{B} is the solid angle volume of bin B.

The Monte Cristo estimation of the integral in (1) is given by,

$${\tilde{f}}_{B} \approx \frac{1}{{Ω}_{B}} \cdot \frac{1}{{N}_{B}} {\sum }_{i = 1}^{{N}_{B}} \frac{f ( {w}_{i} , {w}_{0} )}{{pdf}_{B} ( {w}_{i} , {w}_{0} )} \qquad ( 2 )$$

Here, N_{B} is the number of samples in bin B, and pdf_{B}(wᵢ, w₀) is the pdf.

Normalizing pdf_{B}(wᵢ, w₀) to 1 in terms of pdf_{H}(wᵢ, w₀)

$${\tilde{f}}_{B} \approx \frac{1}{{Ω}_{B}} \cdot \frac{1}{{N}_{B}} {\sum }_{i = 1}^{{N}_{B}} \frac{f ( {w}_{i} , {w}_{0} )}{{pdf}_{H} ( {w}_{i} , {w}_{0} )} \cdot \frac{{N}_{B}}{{N}_{T}} \qquad ( 3 )$$

Where N_{T} is the grand total number of samples over all bins.

$${\tilde{f}}_{B} \approx \frac{{N}_{B}}{{N}_{T}} \cdot \frac{1}{{Ω}_{B}} \cdot \frac{1}{{N}_{B}} {\sum }_{i = 1}^{{N}_{B}} \frac{f ( {w}_{i} , {w}_{0} )}{{pdf}_{H} ( {w}_{i} ) \cdot {pdf}_{H} ( {〚 {w}_{0} \vert w 〛}_{i} )} \qquad ( 4 )$$

For non-uniform w₀ and uniform wᵢ,

$${pdf}_{H} ( {w}_{i} ) = \frac{1}{2 π}$$

$${\tilde{f}}_{B} \approx \frac{2 π}{{Ω}_{B}} \cdot \frac{1}{{N}_{T}} {\sum }_{i = 1}^{{N}_{B}} \frac{f ( {w}_{i} , {w}_{0} )}{{pdf}_{H} ( {〚 {w}_{0} \vert w 〛}_{i} )} \qquad ( 5 )$$

This formulation has the advantage that the exact sample pdf, which is often not available for simulation-based models such as Guo, cancels out. A practical benefit of this formulation is that the training process does not require knowledge of the source model's probability distribution function, which is often intractable for complex, simulation-based materials.

### Adaptive Aggregation

The above-presented uniform aggregation has the advantage of a simple and analytic indexing scheme. To access the value of a (wi,wo)-pair, only a simple 4D array lookup is necessary.

However, many cells are very dark, and the high-intensity areas (specularities) are located in a very small area. This limits the resolution of which specular reflections can be stored and wastefully oversamples low-energy parts of the domain. These specular peaks may contain a significant portion of the material's reflected energy and are perceptually critical for conveying properties like glossiness and surface finish. This inefficient sampling of the domain means that training time is wasted on refining the model's performance in dark, unimportant regions.

To address this issue, an alternative storage scheme using adaptive aggregation is presented.

For a given slice of wi-values, let {wo,c} be the outgoing angles (wo) and color pairs of N samples where the outgoing angles are in the domain [0, pi/2]×[0, 2pi].

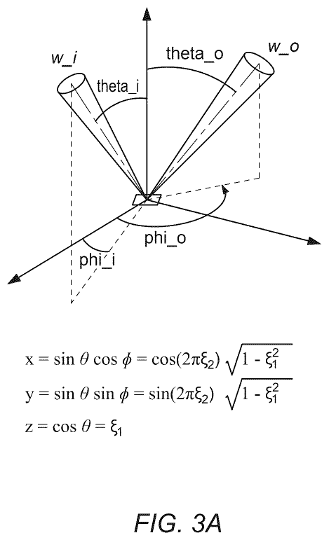

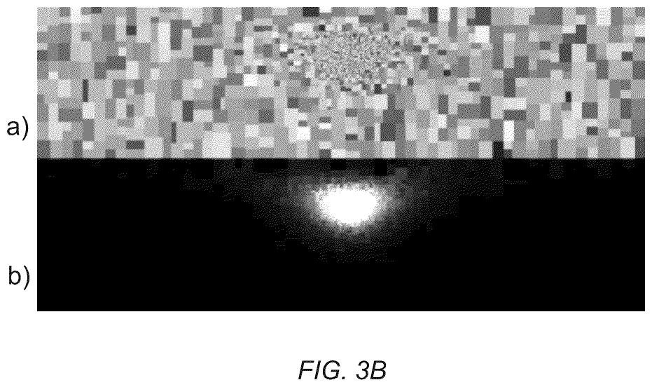

Instead of performing a subdivision of this domain into a uniform grid, an adaptive KD-tree is built out of these samples, as shown in FIGS. 3A and 3B.

As initialization, a node is created covering the entire domain containing all the slice samples. Then, recursively, the node is split along the longest axis based on a pivot position. This pivot position can be specified by (a) the Euclidean center position of all the samples in the node, (b) the median position of the samples, or (c) the point that would lead to the most equal area of the two child nodes after splitting when the node's area are “shrink-wrapped” around the samples within. This recursion continues until the number of samples in a node falls below a user-specified threshold or the node area falls below a user-specified threshold. In that case, the average color of all the samples is assigned as color to the leaf node. These splitting strategies ensure that the tree structure is driven by the data's density, allocating more subdivisions and thus higher resolution to the angular regions where the BRDF values can change most rapidly, such as around specular lobes.

In the case of splitting strategies (a) and (c), the process can result in empty leaves, typically in the areas far away from specular reflections where hardly any light is reflected. These leaves are still included in the representation and training with the color black.

An example of such an adaptive slice can be seen in FIGS. 3A and 3B.

During data generation, one such adaptive KD-tree slice can be generated over wo for each input wi bin. For training, we first sample a wi-range and respective slice and then sample a random leaf node from the KD tree, providing the wo bounds and the average color.

### Supervision

During training, batches of random samples {w_i, w_o, RGB} are sampled. Given the network output T, the target BRDF d: T, w_i, w_o→RGB is evaluated and its output is compared to the value of the training sample using a loss function. Since the training samples represent the average value of all the direction pairs inside the bin, the bin average from the target BRDF is sampled. This can be done by sampling N direction pairs (w_i, w_o)_i that fall inside the bin and averaging d (T, w_i, w_o). The L1 norm of the difference in the log domain is used as a loss function. Operating in the log domain helps to balance the influence of extremely bright specular highlights and darker, diffuse reflections, preventing the network's training from being dominated by high-intensity peaks and leading to better overall perceptual accuracy. This has the effect of lowering the high peak values of specular materials and makes the comparisons not susceptible to a high range of BRDF values.

With adaptively binned training data, the training data is further importance sampled to train on high-energy samples more often. This can be achieved by uniformly sampling leaf nodes of the adaptive tree, which results in higher-energy (and thus smaller) bins to be sampled more often. In some embodiments, by focusing the training effort on these perceptually significant regions, the network converges more quickly to a solution that can accurately reproduce the most important visual features of the material.

By leveraging a differentiable renderer, supervision can also be performed by comparing rendered images instead of the BSDF values or by combining the image and BSDF loss. A differentiable renderer is a rendering engine in which the entire image generation process is differentiable with respect to scene parameters, allowing gradients to be backpropagated from pixel-level image differences all the way back to the BRDF parameters, enabling direct optimization for perceptual similarity. This approach can be made to favor results that are perceptually close to the source BSDF.

### Single Material Training

For single materials, the process is essentially an overfitting to the data for that material. A material can be fit without w_i conditioning, in which case this becomes a much simpler optimization problem without the need for a neural network. The tabulated data is processed in batches, and the target BRDF parameters are optimized to minimize the loss between the evaluated target BRDF and the tabulated data. The result is a set of parameters on the target BRDF that can faithfully render the source BRDF. Since the entire BRDF is learned, the rendering works for any geometry or lighting scenario, and the inference is only needed once.

In case of wi conditioning, the wi direction is fed to a small, fully connected network (MLP), and the parameters of the target BRDF are predicted. The loss and the training mechanism remain the same as in the previous case. It should be noted that a set of target BRDF parameters is output per wi direction instead of a single BRDF for the entire material. The memory footprint of storing the weights of the small MLP is typically orders of magnitude smaller than storing the full 4D tabulated BRDF data, making it an efficient compression scheme. For rendering using this technique, a small inference engine must be in place to predict parameters given an input direction wi.

### Extension to Multiple Materials—Source Model Parameterization

The above method was described for a single material. In this section, the extension to multiple materials is described. In some cases, a goal of this extension is to create a unified model that can generalize across a diverse corpus of materials. Furthermore, the continuous nature of the latent space generated by the encoder allows for the interpolation between different materials, enabling the creation of novel material appearances by blending their latent codes. Having the ability to predict and encode multiple materials in the same model has the benefit of (a) allowing for textured objects where you interpolate between different known materials and (b) generalizing the representation to unknown materials without costly retraining.

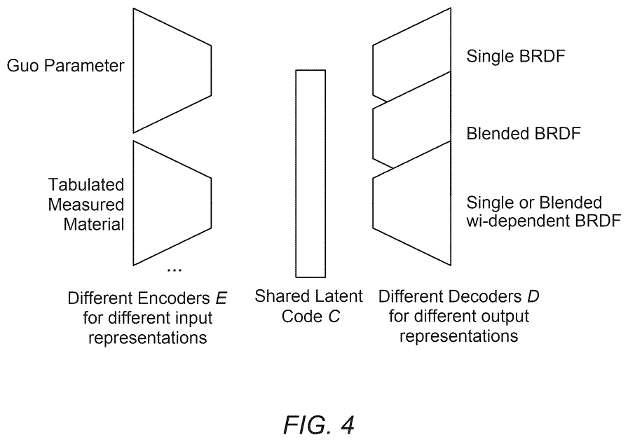

To that end, an encoder-decoder architecture is proposed, as outlined in FIG. 4.

On the encoder side, different neural networks are trained for different input modalities, including Guo parameters, tabulated measured materials, one-hot index into an existing database of materials, and more.

The exact architecture of these networks should be chosen according to the input modality. For example, for the task of encoding the configuration of 3-layer Guo materials, the parameters are stacked together and passed to a multilayer perceptron (MLP). For each layer configuration, a different encoder would have to be trained.

If a measured material tabulated in, e.g., a 4D table is passed as input, the encoder could take the form of an image classification network with the 2D CNNs replaced by 4D CNNs or 2D vision transformers replaced by 4D vision transformers, compressing the image into the latent code. This approach treats the 4D BRDF data as a high-dimensional signal, leveraging the feature-extraction capabilities of convolutional or transformer-based architectures to distill the essential appearance characteristics of the material into a compact and semantically meaningful latent vector.

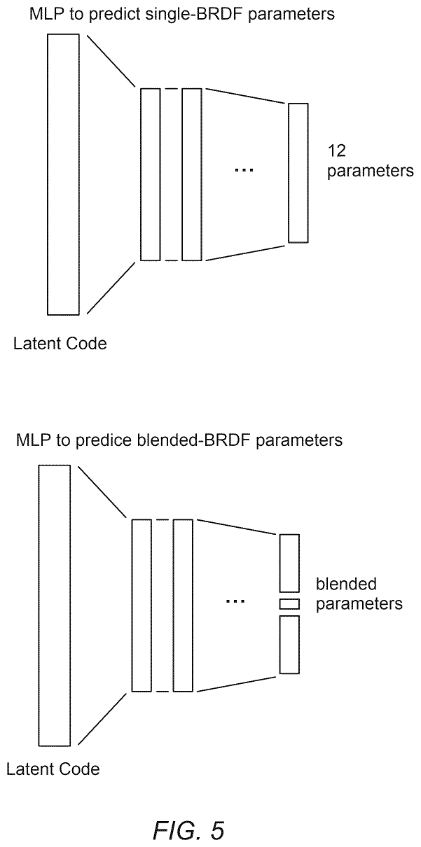

The output of all encoders is a latent code C, a vector of N entries, that is shared among all encoders. Then, different decoders take this latent code and predict the parameters for the individual materials. For non-wi-dependent BSDF adapters, the decoder is realized as an MLP going from the latent code to the 12 Disney BRDF parameters (single BRDF) or the 12+12+1 parameters for a blended BRDF, see FIG. 5.

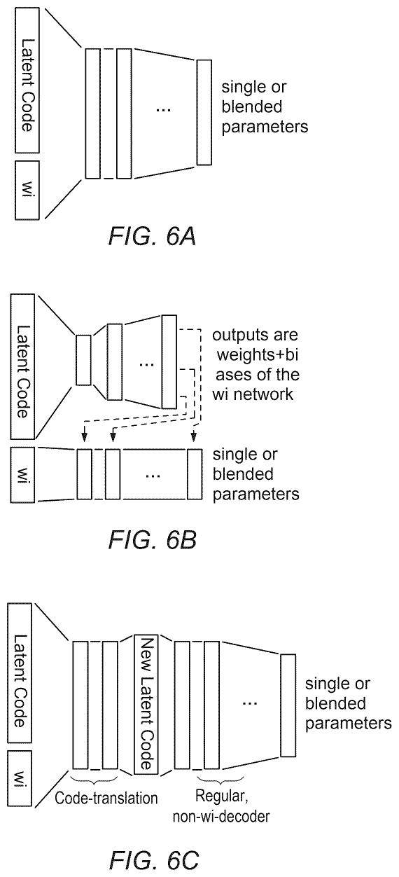

For wi-dependent BSDF adapters, three alternative architectures for the decoder are proposed. First, the wi-network takes the latent code as additional input besides wi (FIG. 6A). The second is to keep the wi-network unchanged (a mapping from wi to BRDF parameters) but use a meta-network for the material decoder (FIG. 6B). This meta-network takes the latent code C and predicts the actual weights of the wi-network. Third, use an MLP that transforms the latent code C into a new code C′ based on wi that is then fed to the standard non-wi-dependent decoders (FIG. 6C). The meta-network approach (FIG. 6B) is more powerful but can be more computationally expensive, while directly feeding the latent code as input (FIG. 6A) is simpler but may be challenged to capture complex interactions between the material identity and the view-dependent effects.

To train the multi-material network, embodiments can use either of the following two options.

First, some embodiments can pre-train the single BSDF adapters following the process outlined in the previous sections. Then, in a second step, the encoders and decoders are trained to predict only the inputs of the single BSDF adapters (e.g., the fitted BSDF parameters for non-wi-adapters or the MLP parameters for the wi-adapters). This reduces memory and computational complexity but can lead to inaccurate fits because the solutions of the single-material fits might end up in different local minima that might be hard to interpolate.

Therefore, in other embodiments, in a second approach the entire system (input encoding, output decoder, material adapter) is trained end-to-end on the entire corpus of materials at once at the same losses as the single material training mentioned above. This holistic training process allows the encoder, decoder, and adapter components to co-adapt, often leading to a more robust and better-generalized final model as the latent space is optimized specifically for the end task of parameter prediction.

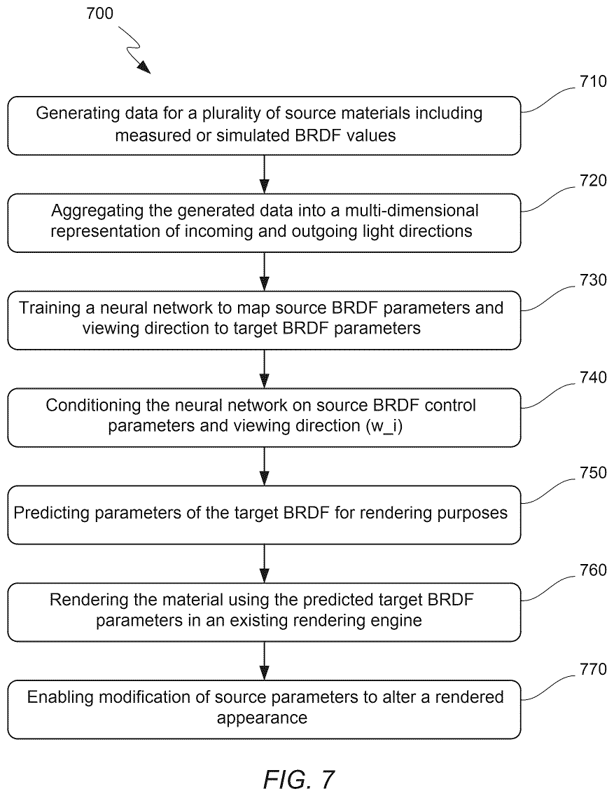

FIG. 7 is a simplified flow chart showing aspects of a method 700 for adapting a source bidirectional reflectance distribution function (BRDF) to a target BRDF using a neural network, according to certain embodiments. Method 700 can be performed by processing logic that may comprise hardware (circuitry, dedicated logic, etc.), software operating on appropriate hardware (such as a general purpose computing system or a dedicated machine), firmware (embedded software), or any combination thereof. In certain embodiments, method 700 can be performed by aspects of system 800 (e.g., processing unit 802).

At operation 710, method 700 can include generating data for a plurality of source materials including measured or simulated BRDF values, according to certain embodiments. Operation 710 can involve generating data for a wide range of source materials. These source materials may be measured directly from real-world samples, resulting in tabulated BRDF values across incoming and outgoing light directions, or they may be simulated using physical models. For simulation, techniques such as Monte Carlo sampling can be used to evaluate the reflectance of the material for different pairs of incoming and outgoing directions, capturing the complexity and variability of material appearance across the sphere of possible lighting conditions.

In some implementations, for each material configuration, the parameters influencing its behavior (e.g., such as layer properties, indices of refraction, roughness, etc.) can be systematically varied within plausible ranges to produce a comprehensive dataset. This dataset provides a robust foundation for training, ensuring that the neural network will generalize well to a variety of materials, including those with complex, multi-layered structures. Data generation may cover thousands of unique materials, with each sample capturing the RGB reflectance for a specific direction pair.

At operation 720, method 700 can include aggregating the generated data into a multi-dimensional representation of incoming and outgoing light directions, according to certain embodiments. Once the raw data is generated, it may be aggregated for efficient training and retrieval. Aggregation can be performed by, for instance, binning the sampled BRDF data into multi-dimensional arrays representing incoming (w_i) and outgoing (w_o) directions. Two primary strategies are typically employed including uniform aggregation and adaptive aggregation.

For uniform aggregation, the sampled direction pairs are uniformly partitioned into bins across the sphere, ensuring that each bin represents an equal solid angle. This approach simplifies indexing and lookup during training but may oversample regions with little variation (e.g., dark areas) and undersample regions of high interest (e.g., specular highlights). For adaptive aggregation, to address the limitations of uniform binning, adaptive aggregation can be performed using data structures such as KD-trees, as further described below. For each slice of incoming directions, the outgoing directions and associated RGB values are organized into a KD-tree, which recursively partitions the domain along the axis of greatest variance. This approach concentrates resolution where the material exhibits high-energy reflections, thereby preserving important features while economizing on storage for uninteresting regions. Both aggregation methods ensure that the neural network receives statistically meaningful training samples and that the loss function can be accurately evaluated during training. As mentioned above, a KD tree (short for k-dimensional tree) is a data structure widely used in computer science, computational geometry, and machine learning for organizing points in a k-dimensional space and often used in tasks such as efficient range searches, nearest neighbor searches, and adaptive binning of high-dimensional data-including applications involving BRDF data. More specifically, a KD tree is a binary tree data structure that recursively partitions space into nested axis-aligned regions, allowing efficient querying and organization of multidimensional data. KD trees can be used for adaptive aggregation of BRDF data, enabling efficient partitioning of angular domains (such as incoming and outgoing light directions) so that high-intensity regions (important for rendering quality) are sampled and stored at higher resolution. This structure can support the training of neural networks by providing statistically meaningful and efficiently indexed training samples, crucial for modeling complex, view-dependent material behaviors.

At operation 730, method 700 can include training a neural network to map source BRDF parameters and viewing direction to target BRDF parameters, according to certain embodiments. The neural network is typically realized as a small multi-layer perceptron (MLP) with three hidden layers, each containing 32 neurons, and an output layer representing the parameter set of the target BRDF (e.g., 12 parameters), though other realizations are possible, as would be appreciated by one of ordinary skill in the art with the benefit of this disclosure. Training may proceed by sampling batches of direction pairs and associated RGB values from the aggregated dataset. For each sample, the neural network is fed the source BRDF parameters and the viewing direction (w_i) and tasked with predicting the target BRDF parameters. The predicted parameters can then be used to evaluate the target BRDF for the same direction pair, and the result is compared to the ground truth using a loss function. The loss is typically computed as the L1 norm of the difference in the logarithmic domain, which provides robustness to high dynamic range in the data and emphasizes perceptual similarity. In some aspects, the training process may include importance sampling, where high-energy bins (regions of strong reflection) are sampled more frequently, further improving the network's accuracy in critical visual areas.

At operation 740, method 700 can include conditioning the neural network on source BRDF control parameters and viewing direction (w_i), according to certain embodiments. This can allow the network to capture both the semantic controllability of the material (e.g., roughness, layer thickness) and the view-dependent effects (e.g., anisotropy, multi-layer specularities). Conditioning on the viewing direction enables the network to model effects that vary with observer orientation, such as gloss, sheen, and directional color shifts. In some aspects, the network does not condition on the light direction (w_o), which preserves the ability to importance sample the target BRDF efficiently during rendering. The conditioning mechanism can thus achieve both expressiveness and efficiency, allowing for rich material appearance without incurring the computational overhead associated with fully neural BRDF representations.

At operation 750, with the network trained and conditioned on relevant inputs, method 700 can include predicting parameters of the target BRDF for rendering purposes, according to certain embodiments. For each rendering event, the source parameters and viewing direction can be input to the network, which outputs the target BRDF parameters. These predicted parameters are then supplied to the rendering engine, which utilizes the existing, efficient implementation of the target BRDF for shading, lighting, and importance sampling. The result can be a rendered material that matches the expressiveness of the source material while leveraging the computational advantages of the target parametric model. Furthermore, the prediction step is computationally lightweight, requiring only a small neural network inference, and is compatible with real-time rendering pipelines.

At operation 760, method 700 can include rendering the material using the predicted target BRDF parameters in an existing rendering engine, according to certain embodiments. Because the parameters correspond directly to the controls of the target BRDF (e.g., base color, roughness, specular, etc.), the rendering process can remain efficient and familiar to artists and engineers. This approach allows for high-quality, physically plausible material appearance without necessitating custom renderers for each new material or neural model. The system supports a wide range of geometries and lighting scenarios, and the rendering process benefits from the mature optimizations present in production rendering software. Furthermore, by decoupling the source material representation from the rendering process, the method is highly extensible and can accommodate future advances in BRDF modeling.

At operation 770, method 700 can include enabling modification of source parameters to alter a rendered appearance, according to certain embodiments. A benefit of the disclosed invention is maintaining full artistic control over the rendered material. Because the neural network is conditioned on the source BRDF parameters, artists can modify these controls in familiar user interfaces to achieve the desired visual outcome. Edits to the source parameters (such as roughness or layer thickness) are immediately reflected in the predicted target BRDF parameters, allowing for iterative design and refinement. The system supports both direct manipulation of semantic parameters and higher-level controls, such as material blending or texture mapping, via the encoder-decoder extension for multiple materials.

It should be appreciated that the specific steps illustrated in FIG. 7 provide a particular method 700 for adapting a source bidirectional reflectance distribution function (BRDF) to a target BRDF using a neural network, according to certain embodiments. Other sequences of steps may also be performed according to alternative embodiments. Furthermore, additional steps may be added or removed depending on the particular application. Any combination of changes can be used and one of ordinary skill in the art with the benefit of this disclosure would understand the many variations, modifications, and alternative embodiments thereof.

### Computer System

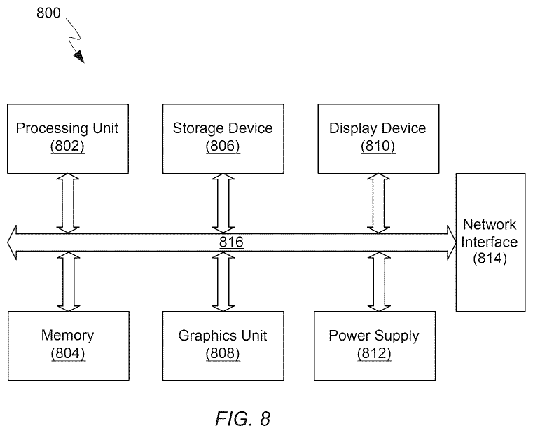

The methods and systems described herein, configured for adapting a source bidirectional reflectance distribution function (BRDF) to a target BRDF using a neural network, may be implemented on a variety of computer systems suitable for graphics processing. Such systems may include, but are not limited to, desktop computers, workstations, servers, cloud-based computing environments, or specialized graphics appliances. Referring now to FIG. 8, an exemplary computer system 800 for graphics processing is illustrated and described below.

Computer system 800 generally includes at least one processor 802, a memory 804, one or more storage devices 806, a graphics processing unit (GPU) 808, a display device 810, one or more input devices 812, and one or more network interfaces 814. These components can be interconnected via a bus or other suitable communication infrastructure 816.

Processor(s) 802 can include one or more central processing units (CPUs), microprocessors, multi-core processors, or combinations thereof. The processor(s) are configured to execute program instructions to perform the steps of the graphics processing methods disclosed herein. Memory 804 can include volatile memory (e.g., random access memory (RAM)), non-volatile memory (e.g., flash, ROM), or combinations thereof. The memory stores program instructions and data that are accessed by the processor(s) during execution of graphics processing tasks.

The one or more storage devices 806 can include hard disk drives (HDDs), solid-state drives (SSDs), optical storage, or other persistent storage media. Storage devices 806 can contain operating system software, application software, graphics libraries, 3D model data, neural network weights, image datasets, and other resources required for graphics processing. Graphics Processing Unit (GPU) 808 can be a specialized hardware component optimized for parallel processing of graphics and image data. GPU 808 can support programmable shader pipelines, CUDA®, OpenCL™, or other parallel computation frameworks, and can include its own dedicated memory. The GPU can be configured to accelerate graphics rendering, machine learning, neural network inference and training, as may be required for methods such as method 700 discussed above.

Display device 810 can include one or more monitors, projectors, virtual reality (VR) headsets, or other devices suitable for presenting visual output generated by the system. Input Devices 812 can keyboards, mice, touchscreens, digitizer tablets, voice input, and/or other user interface devices. Input devices 812 can also include specialized sensors, such as cameras, depth sensors, or motion capture devices, for acquiring data used in graphics processing or avatar creation.

Network interfaces 814 enable communication with other computer systems or devices over a wired or wireless network too allows for distributed or cloud-based processing, remote data acquisition, or collaborative graphics workflows. The bus or communication infrastructure 816 can interconnect all of the above components of system 800 and supports the transfer of data and control signals between them.

Computer system 800 can execute an operating system (e.g., Windows®, macOS®, Linux®), as well as graphics processing software, application-specific modules, and libraries for 3D modeling, rendering, and machine learning (e.g., OpenGL®, Vulkan®, Direct3D®, TensorFlow®, PyTorch®). Program instructions for implementing the methods described herein can be stored in the memory 804 or storage device 806 and executed by the processor(s) 802 and/or GPU 808. Such instructions can be embodied as software modules, plug-ins, or as part of a larger graphics application or pipeline.

In some embodiments, computer system 800 can be part of a distributed computing environment or cloud infrastructure. For example, graphics processing and neural network training may be performed on a cluster of networked servers or in a cloud-based GPU instance, with data and results transmitted to and from client devices via the network interfaces 814.

It will be understood that the configuration of computer system 800 is illustrative and not limiting. In various embodiments, system 800 can include additional hardware components (e.g., FPGAs, ASICs), omit certain components, or be integrated into a mobile device, embedded system, or dedicated appliance.

Additionally, while computer system 800 can implement methods 100 and 200 described above, it is to be understood that software and hardware that is part of the computer system can be viewed as including different modular systems or components that perform various steps of the described methods and/or stages of the described pipelines.

### Additional Embodiments

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not target to be exhaustive or to limit the embodiments to the precise forms disclosed. Also, while different embodiments of the invention were disclosed above, the specific details of particular embodiments may be combined in any suitable manner without departing from the spirit and scope of embodiments of the invention. Further, it will be apparent to one of ordinary skill in the art that many modifications and variations are possible in view of the above teachings.

What is claimed is:

1. A method for adapting a source bidirectional reflectance distribution function (BRDF) to a target BRDF using a neural network, the method comprising:
generating data for a plurality of source materials including measured or simulated BRDF values;
aggregating the generated data into a multi-dimensional representation of incoming and outgoing light directions;
training a neural network to map source BRDF parameters and viewing direction to target BRDF parameters;
conditioning the neural network on source BRDF control parameters and viewing direction;
predicting parameters of the target BRDF for rendering purposes; and
rendering the material using the predicted target BRDF parameters in an existing rendering engine.

2. The method of claim 1, further comprising enabling user-modification of source parameters to alter a rendered appearance.

3. The method of claim 1, wherein the neural network comprises a multi-layer perceptron (MLP) with at least three hidden layers and at least twelve output nodes corresponding to target BRDF parameters.

4. The method of claim 1, further comprising generating training data by sampling direction pairs over a sphere and aggregating samples using uniform or adaptive binning strategies.

5. The method of claim 1, wherein adaptive binning is performed using a KD-tree structure to emphasize high-intensity areas of the BRDF parameters.

6. The method of claim 1, wherein the training of the neural network is supervised using a loss function comparing target BRDF output to average values of sampled bins, utilizing importance sampling for high-energy samples.

7. The method of claim 1, further comprising extending the neural network to encode multiple materials using an encoder-decoder architecture, wherein different encoders process different input modalities and output a shared latent code for decoding material parameters.

8. The method of claim 1, wherein the neural network enables view-dependent adaptation by conditioning on the viewing direction without conditioning on the light direction, thereby facilitating efficient importance sampling in rendering.

9. A system for neural view-dependent adaptation of BRDF parameters comprising:
a data generation module configured to simulate or measure material BRDFs;
an aggregation module configured to organize data into multi-dimensional bins;
a neural network module configured to map source BRDF parameters and viewing direction to target BRDF parameters;
an encoder-decoder architecture for handling multiple materials; and
a rendering engine configured to render materials using the predicted target BRDF parameters.

10. The system of claim 9, wherein the data generation module comprises Monte Carlo sampling of incoming and outgoing directions over a sphere.

11. The system of claim 9, wherein the aggregation module is further configured to perform adaptive binning using a KD-tree structure.

12. The system of claim 9, wherein the neural network module includes a multi-layer perceptron with trainable weights, configured to output at least twelve parameters for the target BRDF.

13. The system of claim 9, wherein the encoder-decoder architecture includes encoders for various input modalities and decoders for predicting target BRDF parameters from a shared latent code.

14. The system of claim 9, wherein the rendering engine is configured for efficient importance sampling and artist-controllable parameter modification.

15. The system of claim 9, wherein the neural network module is trained end-to-end on a corpus of materials to optimize rendering accuracy and generalizability.

16. A non-transitory computer-readable medium storing instructions that, when executed by a processor, cause the processor to perform a method for neural view-dependent BRDF adaptation, the method comprising:
receiving source BRDF data;
aggregating data into bins based on incoming and outgoing directions;
training a neural network to map source parameters and viewing direction to target BRDF parameters; and
predicting target BRDF parameters for rendering.

17. The computer-readable medium of claim 16, wherein the instructions further cause the processor to perform adaptive binning of BRDF data using a KD-tree structure.

18. The computer-readable medium of claim 16, wherein the instructions further cause the processor to supervise training using a loss function comparing predicted RGB values to aggregated bin averages.

19. The computer-readable medium of claim 16, wherein the instructions further cause the processor to extend the neural network to encode multiple materials using an encoder-decoder architecture.

20. The computer-readable medium of claim 16, wherein the instructions further cause the processor to:
enable view-dependent adaptation by conditioning the neural network on viewing direction but not on light direction; and
allow a modification of source parameters to alter rendered appearance.
